(19) United States
(12) Patent Application Publication
(10) Pub. No.: US 2014/0156243 A1
(43) Pub. Date: Jun. 5, 2014

(54) FAN SELECTION SYSTEM AND METHOD

(71) Applicant: HON HAI PRECISION INDUSTRY CO., LTD., New Taipei (TW)

(72) Inventors: CHENG-HSIU YANG, New Taipei (TW); CHIN-HUI CHEN, New Taipei (TW); HUNG-CHOU CHAN, New Taipei (TW)

(73) Assignee: HON HAI PRECISION INDUSTRY CO., LTD., New Taipei (TW)

(21) Appl. No.: 13/951,370

(22) Filed: Jul. 25, 2013

(30) Foreign Application Priority Data
Dec. 5, 2012 (TW) 101145761

(51) Int. Cl. G06F 17/50

(52) U.S. Cl. CPC G06F 17/50
USPC 703/9

(57) ABSTRACT

A fan selection method is provided. The method determines an optimal amount of each type of fan to be used in a cabinet. The optimal amount of each type of fan is determined by an intersection between a fan performance curve and an airflow resistance curve of the cabinet. The model number and optimal amount of each type of fan is output to a user.

### BACKGROUND

1. Technical Field

The present disclosure relates to a fan selection system and method.

2. Description of Related Art

A number of fans are usually configured in a cabinet for dissipating heat generated by servers within the cabinet. However, different cabinets have different parameters, such as size, flow resistance etc., the different fans have the different specification data such as, a model number of the fan, a dimension of the fan etc., it is time-consuming for the user to manually select the suitable fans from a number of fans with the different specification data based on the parameters of the cabinet.

Therefore, what is needed is a fan selection system and method to overcome the above described limitations.

### BRIEF DESCRIPTION OF THE DRAWING

FIG. 1 is a schematic diagram of a fan selection system in accordance with an exemplary embodiment.

FIGS. 2-4 show a process for selecting the fans implemented by the fan selection system of FIG. 1.

FIG. 5 is a flowchart of a fan selection method implemented by the fan selection system of FIG. 1, in accordance with an exemplary embodiment.

### DETAILED DESCRIPTION

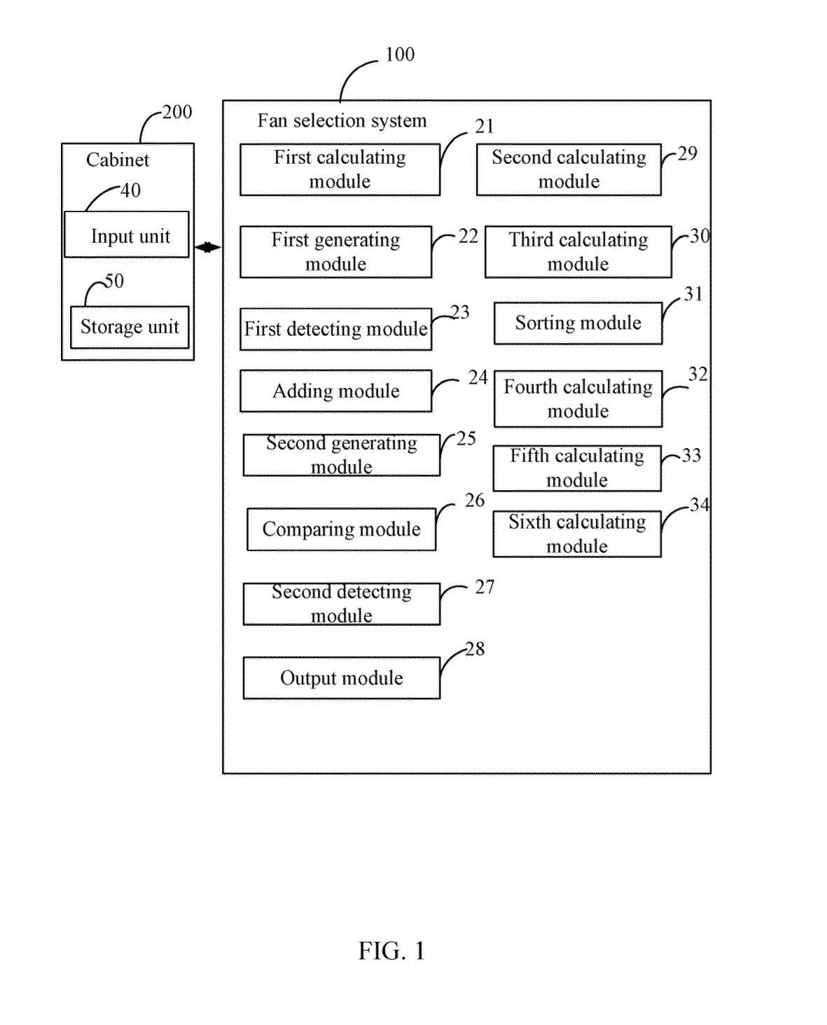

Referring to FIG. 1, a fan selection system 100 runs in a cabinet 200. The cabinet 200 includes an input unit 40 and a storage unit 50. The input unit 40 receives the cabinet's parameters input by a user. In one embodiment, the cabinet's parameters include a size, an airflow resistance, and a minimum airflow value of the cabinet. In other embodiments, the cabinet's parameters further include a current input manner, such as a direct current (DC) manner, an alternating current (AC) manner, or an eddy current (EC) manner. The storage unit 50 stores distinguishable specification data for a plurality of types of fans. In one embodiment, the distinguishable specification data of each type of fan includes a model number, size, and a fan performance curve. The fan performance curve is relative to a amount of the fans. For example, the fan performance curve of one fan “A” is different from the fan performance curve of two fans “A”. In other embodiments, the distinguishable specification data of each type of fan further includes a type, a vendor, an airflow speed, a voltage, and a current of the fan.

In one embodiment, the input unit 40 is used to import a file that records the airflow resistance of the cabinet. In other embodiments, the input unit 40 directly receives the airflow resistance of the cabinet input by the user.

The fan selection system 100 includes a first calculating module 21, a first generating module 22, a first detecting module 23, an adding module 24, a second generating module 25, a comparing module 26, a second detecting module 27, and an output module 28.

The first calculating module 21 reads the specification data of each type of fan, and determines a maximum amount of each type of fan that can be placed within the cabinet, based on the size of each type of fan and the size of the cabinet. For example, if the length of the cabinet is 9 meters, and the length of a fan “A” is 2 meters, then the maximum allowed amount of the fan “A” is 4.

The first generating module 22 generates an airflow resistance curve based on the airflow resistance of the cabinet. The first detecting module 23 detects whether or not there is an intersection between the fan performance curve of each type of fan and the airflow resistance curve of the cabinet 200. For the types of fans that have fan performance curves that intersect with the airflow resistance curve of the cabinet 200, the first calculating module 21 determines that the required amount of the fan is one. For the types of fans with performance curves that don't intersect with the resistance curve of the cabinet 200, the adding module 24 increases the amount of the fan by one.

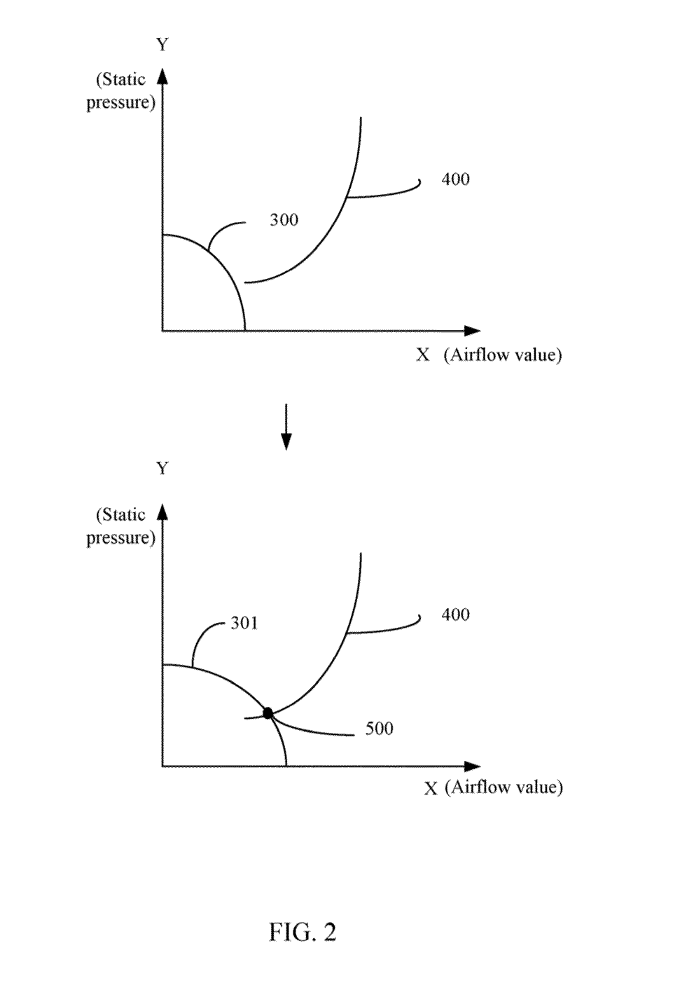

The second generating module 25 generates a fan performance curve corresponding to the current amount of the fan plus one for each type of fan that doesn't have a fan performance curve intersecting with the airflow resistance curve of the cabinet 200. As shown in FIG. 2, a fan performance curve 300 corresponding to one fan “A” does not intersect with an airflow resistance curve 400 of the cabinet, but when the amount of the fan “A” is added by one, a fan performance curve 301 intersects with the airflow resistance curve 400 of the cabinet 200.

When the fan performance curve of each type of fan intersects with the airflow resistance curve of the cabinet 200, the comparing module 26 determines whether or not the current amount of each type of fan is greater than the maximum allowed amount of fans.

The second detecting module 27 detects whether or not an airflow value of the current amount of each type of fan is more than the minimum airflow value of the cabinet 200. If a type of fan has an airflow value that is greater than the minimum airflow value of the cabinet 200, the output module 28 outputs the model number and the optimal amount of the type of fan to a display interface.

The specification data of the fans further includes an operation cost of electricity, a power consumption value, a life expectancy value, and a rough cost value. The fan selection system 100 further includes a second calculating module 29, a third calculating module 30, and a sorting module 31. The second calculating module 29 calculates a first money value of each type of fan based on the operation cost of electricity, the power consumption value, and the life expectancy value of the optimal amount of the fans. In one embodiment, the first money value is obtained by multiplying the power consumption value, the optimal amount of the fans, the life expectancy value, and the operation cost of electricity together, and then multiplying the obtained value by 8760.

The third calculating module 30 calculates a second money value based on the life expectancy value and the rough cost value of each type of fan when the airflow value corresponding to the intersection is more than the minimum airflow value of the cabinet. In one embodiment, the second money value is obtained by multiplying the rough cost value, the optimal amount of the fans, and the life expectancy value each type of fan together, and then multiplying the value by 8760.

The sorting module 31 sorts each type of fan according to the first money value in ascending order. The sorting module 31 further sorts each type of fan according to the second money value in ascending order.

The fan selection system 100 further includes a fourth calculating module 32. The fourth calculating module 32 calculates a sum of the first money value and the second money value. The sorting module 31 further sorts each type of fan according to the sum in ascending order.

The fan selection system 100 further includes a fifth calculating module 33. The fifth calculating module 33 calculates an efficiency value of each type of fan based on the airflow value of the current amount of fans corresponding to the intersection, and the power consumption value of the fans. The sorting module 31 further sorts each type of fan with different model numbers according to the efficiency value in descending order. In one embodiment, the efficiency value of each type of fan is equal to the airflow value divided by the power consumption value.

The specification data of each type of fan further includes a noise value. The fan selection system 100 further includes a sixth calculating module 34. The sixth calculating module 34 calculates a sum of the noise values of the optimal amount of each type of fan. The sorting module 31 further sorts each type of fan according to the sum of the noise values in ascending order.

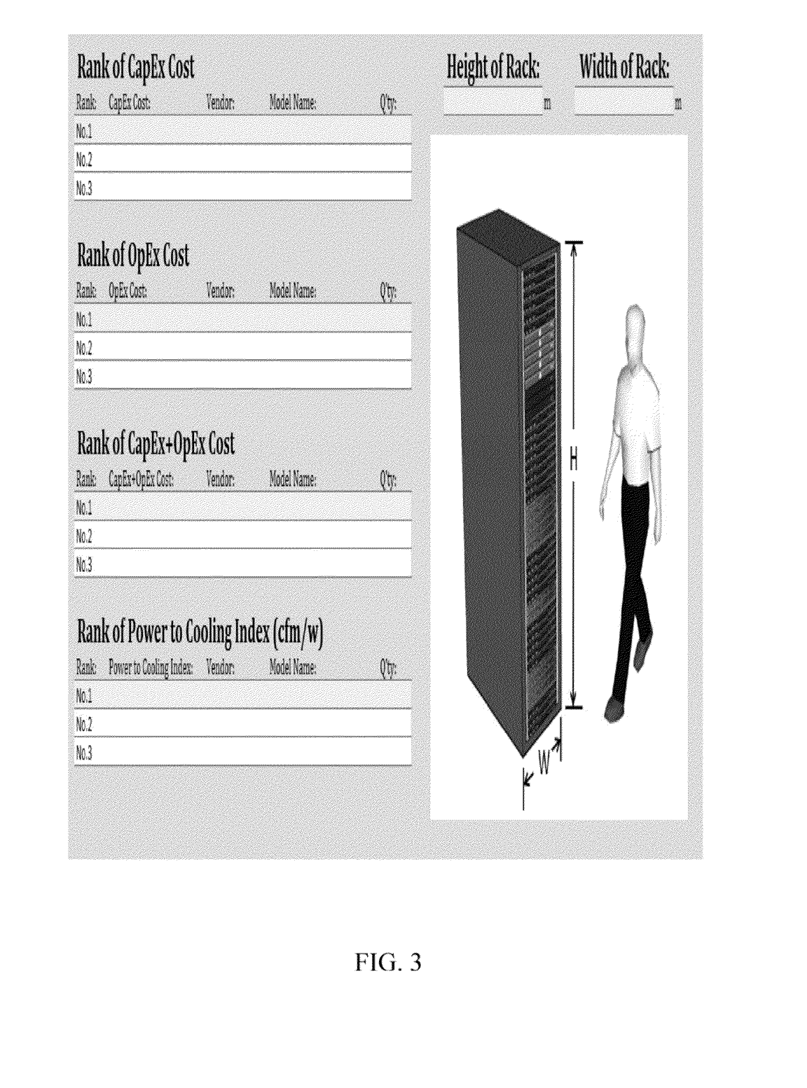

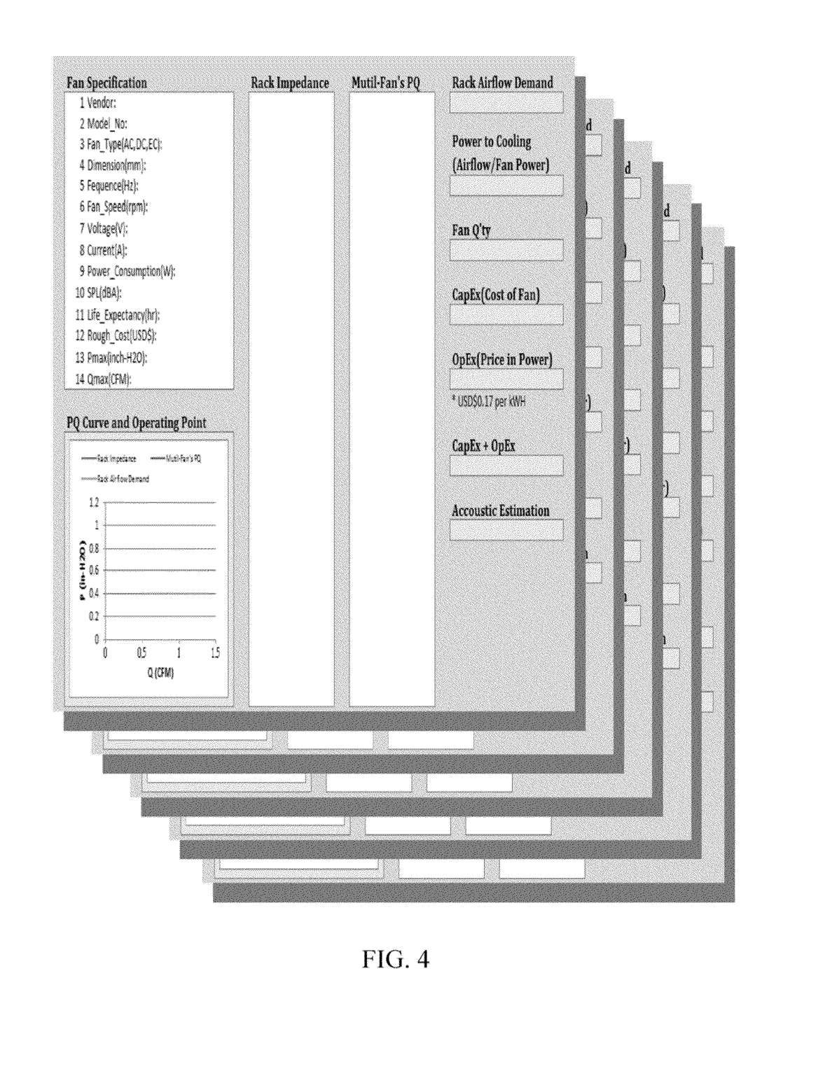

Referring to FIGS. 3-4, the output module 28 further outputs a file that includes a first sub-file and a second sub-file. The first sub-file includes one page, which displays the model number and the optimal amount of the top three fans according to each of the first money value, the second money value, the sum of the first money value and the second money value of the fans, the efficiency value of the fans, and the sum of the noise value of the fans. The second sub-file includes a number of pages. Each page of the second sub-file displays the specification data of each type of fan and a graph of the fan performance curve corresponding to an optimal amount of the fan intersecting with the airflow resistance curve of the cabinet. Each page of the second sub-file further displays an evaluation value of the first money value, the second money value, the sum of the first money value and the second money value, the efficiency value, the sum of the noise values, and the optimal amount of each type of fan. The evaluation value is obtained by weighing the first money value, the second money value, the sum of the first money value and the second money value, the efficiency value, the sum of the noise values, and the optimal amount of each type of fan with predetermined coefficients.

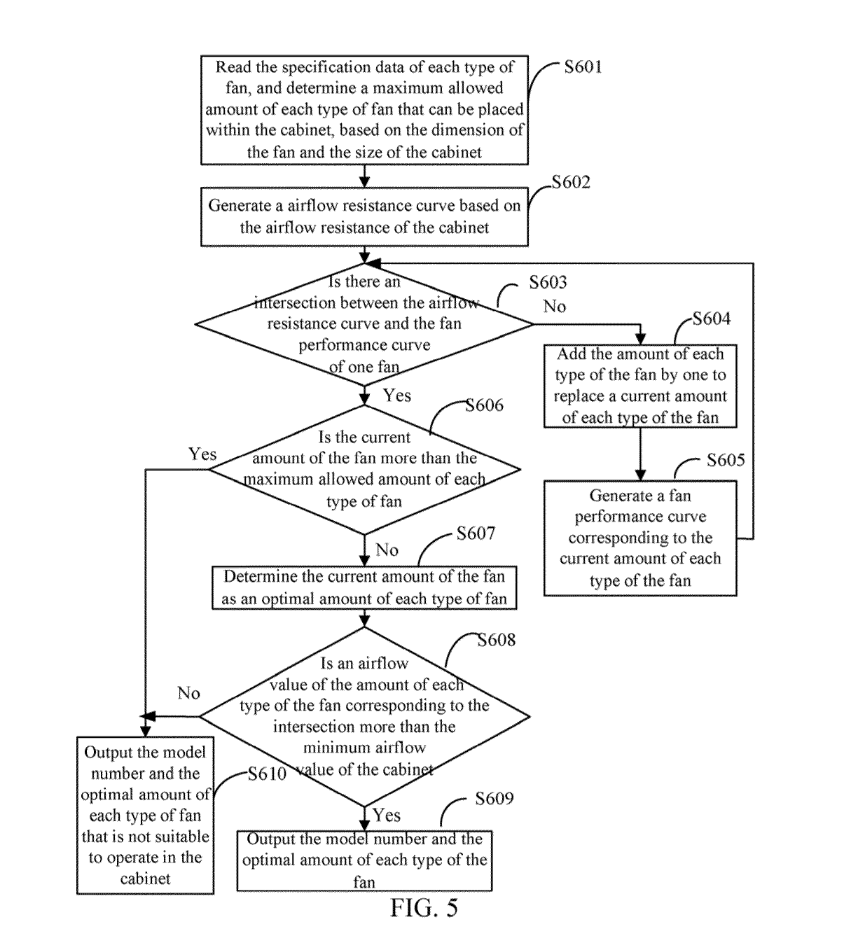

FIG. 5 is a flowchart of a fan selection method implemented by the fan selection system of FIG. 1, in accordance with an exemplary embodiment.

In step S601, the first calculating module 21 reads the specification data of each type of fan, and determines a maximum amount of each type of fan that can be placed within the cabinet, based on the size of the fans and the size of the cabinet.

In step S602, the first generating module 22 generates an airflow resistance curve based on the airflow resistance of the cabinet received by the input unit 40.

In step S603, the first detecting module 23 detects whether or not there is an intersection between the fan performance curve of each type of fan and the airflow resistance curve of the cabinet 200; for the types of fans with performance curves that intersect the resistance curve of the cabinet 200, the procedure goes to step S606; for the types of fans with performance curves that don't intersect the airflow resistance curve of the cabinet 200, the procedure goes to step S604.

In step S604, the adding module 24 adds the amount of each type of fan by one.

In step S605, the second generating module 25 generates a fan performance curve corresponding to the current amount of each type of fan, and the procedure goes to step S603.

In step S606, the comparing module 26 compares whether or not the current amount of each type of fan is more than the maximum allowed amount of the fans; each type of fan with a current amount of fans greater than the maximum allowed amount of fans is rejected by the procedure; each type of fan that does not exceed the maximum allowed amount of fans continues to step S607.

In step S607, the comparing module 26 determines the current amount of each type of fan as an optimal amount of fans.

In step S608, the second detecting module 27 detects whether or not an airflow value of each type of fan corresponding to the intersection is more than the minimum airflow value of the cabinet 200; each type of fan with an airflow value greater than the minimum airflow value of the cabinet 200 continues to step S609; each type of fan with airflow values less than the minimum airflow value of the cabinet 200 is rejected by the procedure.

In step S609, the output module 28 outputs to a display interface the model number and the optimal amount of each type of fan that is suitable to operate in the cabinet 200.

After step S609, the user can choose which type of fan to use in the cabinet 200 according to the first money value, the second money, the sum of the first money value and the second money value, the efficiency value, and the sum of the noise values of the fans.

Although various embodiments have been specifically described, the disclosure is not to be construed as being limited thereto. Various changes or modifications may be made to the embodiments without departing from the scope and spirit of the disclosure.

What is claimed is:

1. A fan selection system being run in a cabinet, wherein the cabinet comprises an input unit and a storage unit, the input unit is configured to receive parameters of the cabinet, the parameters comprise a size, an airflow resistance, and a minimum airflow value of the cabinet, the storage unit is configured to store specification data for a plurality of types of fans, the specification data for each type of fan comprises a model number, a dimension, and a fan performance curve which is relative to a amount of the fans, the fan selection system comprising:
one or more processors; and
a plurality of modules to be executed by the one or more processors, wherein the plurality of modules comprises:
a first calculating module configured to read the specification data of each type of fan, and determine a maximum allowed amount of each type of fan that can be placed within the cabinet, based on the dimension of the fan and the size of the cabinet;
a first generating module configured to generate an airflow resistance curve based on the airflow resistance of the cabinet input to the input unit;
a first detecting module configured to detect whether or not there is an intersection between the fan performance curve of one fan and the airflow resistance curve of the cabinet;
an adding module configured to add the amount of the fan by one to replace a current amount of the fan when there is no intersection between the fan performance curve of one fan and the airflow resistance curve of the cabinet;
a second generating module configured to generate a fan performance curve corresponding to the current amount of the fan;
the first detecting module further configured to detect whether or not there is an intersection between the airflow resistance curve of the cabinet and the fan performance curve corresponding to the current amount of the fan;
a comparing module configured to compare whether or not the current amount of the fan is more than the maximum allowed amount of the fan when there is an intersection between the airflow resistance curve of the cabinet and the fan performance curve corresponding to the current amount of the fan, and determine the current amount as an optimal amount of the fan when the current amount of the fan is not more than the maximum allowed amount of the fan;
a second detecting module configured to detect whether or not an airflow value of the current amount of the fan corresponding to the intersection is more than the minimum airflow value of the cabinet; and
an output module configured to output the model number and the optimal amount of the fan to a display interface when the airflow value of the fan of the current amount of the fan corresponding to the intersection is more than the minimum airflow value of the cabinet.

2. The fan selection system as described in claim 1, wherein the specification data of the fans further comprise an operation cost of electricity, a power consumption value, a life expectancy value and a rough cost value of the fan, the plurality of modules further comprises:
a second calculating module configured to calculate a first money value based on the operation cost of electricity, the power consumption value of fan and the life expectancy value of the fans when the airflow value of the current amount of the fan corresponding to the intersection is more than the minimum airflow value of the cabinet;
a third calculating module configured to calculate a second money value based on the life expectancy value of the fan and the rough cost value of the fan when the airflow value of the current amount of the fan corresponding to the intersection is more than the minimum airflow value of the cabinet;
a sorting module configured to sort the fans according to the first money value in an ascending order; and
the sorting module further configured to sort the fan according to the second money value in an ascending order.

3. The fan selection system as described in claim 2, wherein the plurality of modules further comprises:
a fourth calculating module configured to calculate a sum of the first money value and the second money value; and
the sorting module further configured to sort the fans according to the sum in an ascending order.

4. The fan selection system as described in claim 3, wherein the plurality of modules further comprises:
a fifth calculating module configured to calculate an efficiency value of the fan based on the airflow value of the current amount of fans corresponding to the intersection and the power consumption value of the fan; and
the sorting module further configured to sort the fans according to the efficiency value in a descending order.

5. The fan selection system as described in claim 4, wherein the specification data of each type of fan further comprises a noise value, the plurality of modules further comprises:
a sixth calculating module configured to calculate a sum of the noise value of the optimal amount of the fans; and
the sorting module further configured to sort the fans according to the sum of the noise value in an ascending order.

6. The fan selection system as described in claim 5, wherein the output module is configured to output a file which comprises a first sub-file, the first sub-file comprises one page which displays the model number and the optimal amount of the top three fans according to each of the first money value, the second money value, the sum of the first money value and the second money value of the fans, the efficiency value of the fans, and the sum of the noise value of the fans.

7. The fan selection system as described in claim 6, wherein the file further comprises a second sub-file, the second sub-file comprises a plurality of pages, each page of the second sub-file displays the specification data of each type of fan and a graph of the fan performance curve corresponding to an optimal amount of the fan intersecting with the airflow resistance curve of the cabinet.

8. The fan selection system as described in claim 7, wherein each page of the second sub-file further displays an evaluation value of the first money value, the second money value, the sum of the first money value and the second money value, the efficiency value, the sum of the noise values, and the optimal amount of each type of fan.

9. A fan selection method being run in a cabinet, wherein the cabinet comprises an input unit and a storage unit, the input unit is configured to receive parameters of the cabinet, the parameters comprise a size, an airflow resistance and a minimum airflow value of the cabinet, the storage unit is configured to store specification data for a plurality of types of fans, the specification data for the each type of fan comprises a model number, a dimension and a fan performance curve which is relative to a amount of the fans, the fan selection method comprising:
reading the specification data of each type of fan, and determine a maximum allowed amount of each type of fan that can be placed within the cabinet, based on the dimension of the fan and the size of the cabinet;
generating an airflow resistance curve based on the airflow resistance of the cabinet input to the input unit;
detecting whether or not there is an intersection between the airflow resistance curve of the cabinet and the fan performance curve of one fan;
adding the amount of the fan by one to replace a current amount of the fan when there is no intersection between the airflow resistance curve of the cabinet and the fan performance curve of one fan;
generating a fan performance curve corresponding to the current amount of the fan;
detecting whether or not there is an intersection between airflow resistance curve of the cabinet and the fan performance curve corresponding to the current amount of the fan and;
comparing whether or not the current amount of the fan is more than the maximum allowed amount of the fan when there is an intersection between the airflow resistance curve of the cabinet and the fan performance curve corresponding to the current amount of the fan, and determining the current amount as an optimal amount of the fan when the current amount of the fan is not more than the maximum allowed amount of the fan;
detecting whether or not an airflow value of the current amount of the fan corresponding to the intersection is more than the minimum airflow value of the cabinet; and
outputting to a display interface the model number and the optimal amount of the fan when the airflow value of the fan of the current amount of fan corresponding to the intersection is more than the minimum airflow value of the cabinet.

10. The fan selection method as described in claim 9, wherein the specification data of the fans further comprise an operation cost of electricity, a power consumption value, a life expectancy value and a rough cost value of the fan, the method comprising:
calculating a first money value based on the operation cost of electricity, the power consumption value of fan and the life expectancy value of the fans when the airflow value of the current amount of the fan corresponding to the intersection is more than the minimum airflow value of the cabinet;
calculating a second money value based on the life expectancy value of the fan and the rough cost value of the fan when the airflow value of the current amount of the fan corresponding to the intersection is more than the minimum airflow value of the cabinet;
sorting the fans according to the first money value in an ascending order; and
sorting the fan according to the second money value in an ascending order.

11. The fan selection method as described in claim 10, further comprising:
calculating a sum of the first money value and the second money value; and
sorting the fans according to the sum in an ascending order.

12. The fan selection method as described in claim 11, further comprising:
calculating an efficiency value of the fan based on the airflow value of the current amount of fans corresponding to the intersection and the power consumption value of the fan; and
sorting the fans according to the efficiency value in a descending order.

13. The fan selection method as described in claim 12, wherein the specification data of each type of fan further comprises a noise value, the method comprises:
calculating a sum of the noise value of the optimal amount of the fans; and
sorting the fans with the different model number according to the sum of the noise value in an ascending order.

14. The fan selection method as described in claim 13, further comprising:
outputting a file which comprises a first sub-file which comprises one page; and
displaying the model number and the optimal amount of the top three fans according to each of the first money value, the second money value, the sum of the first money value and the second money value of the fans, the efficiency value of the fans, and the sum of the noise value of the fans on the page one of the first sub-file.

15. The fan selection method as described in claim 14, wherein the file further comprises a second sub-file which comprises a plurality of pages, the method comprising:
displaying the specification data of each type of fan and a graph of the fan performance curve corresponding to an optimal amount of the fan intersecting with the airflow resistance curve of the cabinet on each page of the second sub-file.

16. The fan selection method as described in claim 15, further comprising:
displaying an evaluation value of the first money value, the second money value, the sum of the first money value and the second money value, the efficiency value, the sum of the noise values, and the optimal amount of each type of fan on each page of the second sub-file.
